(19) United States
(12) Patent Application Publication
(10) Pub. No.: US 2007/0053347 A1
(43) Pub. Date: Mar. 8, 2007

(54) COMMUNICATION METHOD, COMMUNICATION APPARATUS AND COMMUNICATION SYSTEM AND PROCESSING METHOD AND PROCESSING APPARATUS

(76) Inventor: Osamu SASAKI, Tokyo (JP)

Correspondence Address: MORGAN & FINNEGAN, L.L.P., 3 WORLD FINANCIAL CENTER, NEW YORK, NY, 10281-2101, US

(21) Appl. No.: 11/470,763

(22) Filed: Sep. 7, 2006

(30) Foreign Application Priority Data
Sep. 8, 2005 (JP) 2005-261099
Oct. 12, 2005 (JP) 2005-298097

(51) Int. Cl. H04L 12/66

(52) U.S. Cl. 370/352

(57) ABSTRACT

A communication device selects one of a remote or local transmitters according to the destination of a message, transmits the message from the selected transmitter, receives the message at a receiver, and transmits the received message to the destination of the message.

### BACKGROUND OF THE INVENTION

1. Field of the Invention

The present invention relates to a communication method, communication apparatus and communication system and a processing method and processing apparatus.

2. Description of the Related Art

There has been much interest in WEB service technology using SOAP in communication between computer programs via a network. The communication in the service using SOAP is generally used in an environment distributed on the network. Consider a client located on a network employs a Web service executed on another node located on the network. In this case, the client transmits a request to the service via the network and the service returns a reply via the network.

However, the node executing the service may be not only on the network but also may be the node including the client. In this case, in the service using SOAP, the client employs the service in its own node via the network. Therefore, a process in which a SOAP message is created and transmitted to a network and then the SOAP message is received from the network and interpreted would also be performed for the service executed in the node including the client. Therefore, overhead via the network will occurs even if an application program is executed on the same node.

It is also considered that a requesting client program directly executes an application program executed by the service. However, it is not easy to migrate from a system or program constructed as a service on a network to a client program executed by itself.

Creating a program with taking into account whether a service is used via a network or in its own node will be an extra burden on a programmer.

### SUMMARY OF THE INVENTION

It is an object of the present invention to provide a communication method, communication apparatus and communication system which can transmit a message to its own sender side of the message without overhead via a network.

It is an object of the present invention to provide a communication method, communication apparatus and communication system which can be provided with a service running on its own node without overhead via a network.

It is an object of the present invention to provide a communication method, communication apparatus and communication system which can be provided with a service running on its own node in a single process without overhead via a network and without taking into account whether the service is provided via the network or is a service provided by its own node.

It is an object of the present invention to provide a communication method, comprising the steps of: selecting one of remote and local transmitters according to the destination of a message, transmitting the message from the transmitter selected in the selection step, receiving the message at a receiver, and transmitting the message to the destination of the message received in the receiving step.

It is an object of the present invention to provide a communication apparatus, comprising selection means for selecting one of remote and local transmitters according to the destination of a message, first transmission means for transmitting the message from the transmitter selected by the selection means, reception means for receiving the message at a receiver, and second transmission means for transmitting the message to the destination of the message received by the reception means.

It is an object of the present invention to provide a communication method, comprising the steps of: acquiring a parameter from Web service description, and selecting a remote transmitter or an invocation unit in a local module according to the acquired parameter.

It is an object of the present invention to provide a method for processing Web service description, comprising the steps of: acquiring a parameter from the Web service description, and selecting a remote transmitter or an invocation unit in a local module according to the acquired parameter.

It is an object of the present invention to provide a device for processing Web service description, comprising processing means for acquiring a parameter from the Web service description, and selection means for selecting a remote transmitter or an invocation unit in a local module according to the acquired parameter.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a conceptual diagram schematically showing a data communication system according to a first embodiment of the present invention;

FIG. 2 is a block diagram describing a hardware configuration of a communication apparatus according to the present embodiment;

FIG. 3 is a block diagram describing a remote communication in the communication system according to the present embodiment;

FIG. 4 is a block diagram describing a local communication in the communication system according to the present embodiment;

FIG. 5 is a conceptual diagram schematically showing a service utilization system according to a second embodiment of the present invention;

FIG. 6 depicts a view illustrating a specific example of WSDL description extended to describe a service executed on the same node on a network as a client application;

FIG. 7 is a conceptual diagram showing a service utilization system and its functions according to the present embodiment using a service employing SOAP Binding as an example;

FIG. 8 is a conceptual diagram showing a service utilization system and its functions according to the present embodiment using a service on the same node on a network as a client application as an example; and

FIG. 9 is a conceptual diagram showing more detailed functions of WSDL recognizer of a service utilization system and its functions according to the present embodiment.

### DESCRIPTION OF THE EMBODIMENTS

Preferred embodiments of the present invention will be described in detail with reference to the accompanying drawings. It should be noted that the embodiments below do not limit the present invention set forth in the claims and that all combinations of features described in the embodiments are not necessarily essential as means for attaining the objects of the invention. In the present invention, the method, system or apparatus may be implemented as a program usable in a computer. Therefore, the present invention may have an embodiment as hardware and/or software. The program may be recorded in any computer-readable medium such as a hard disk, CD-ROM, optical storage device, magnetic storage device or flash memory.

The system available in the following embodiments may be a general computer system. The computer system available in the present embodiments includes various computers such as a personal computer, workstation, main frame computer and device-embedded computer. Environments running the program described in the present embodiments have no particular restriction. OS and programming languages are also not limited.

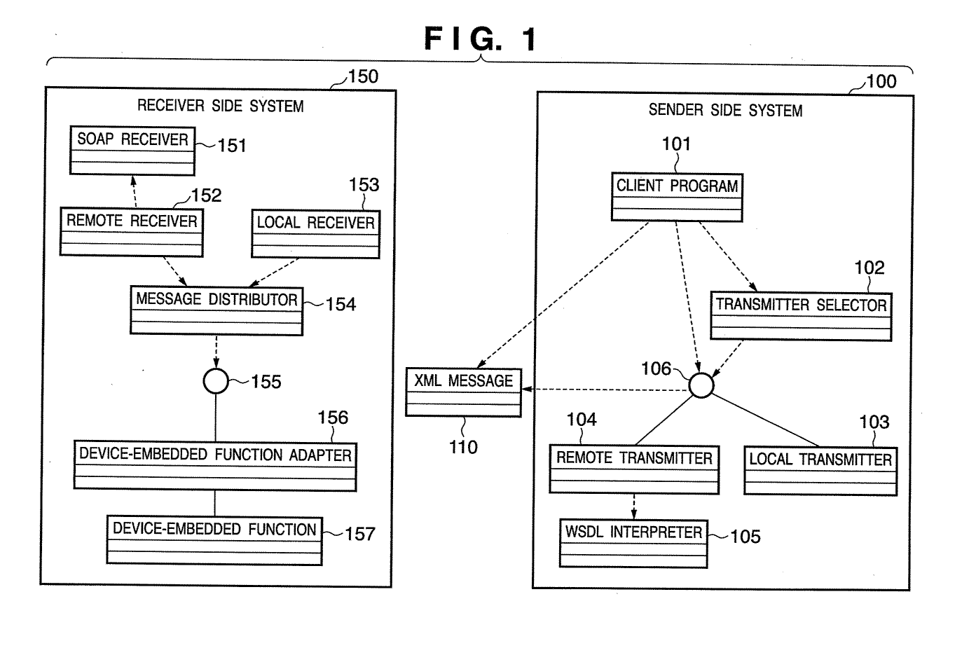

FIG. 1 is a conceptual diagram schematically showing a data communication system according to a first embodiment of the present invention.

The data communication system performs data communication between a client program 101 in a sender side system 100 and a device-embedded function 157 in a receiver side system 150. The sender side system 100 has a transmission interface 106 which is common to a transmitter selector 102, a local transmitter 103 and a remote transmitter 104. A WSDL interpreter 105 verifies a data in an inputted XML message 110 and transmits it along with the destination as a SOAP message to a remote node. This allows the remote transmitter 104 to use a Web service in other nodes on a network.

The receiver side system 150 has a SOAP receiver 151, a remote receiver 152, a local receiver 153 and a message distributor 154. The receiver side system 150 further has one or more device-embedded functions 157 of the receiver side system 150 used by the client program 101. The receiver side system 150 has one or more device-embedded function adapters (adapter class) 156 for associating each device-embedded function 157 with a common reception interface 155.

Here, the transmission interface 106 and the reception interface 155 respectively receive an XML message 110 as an input and output it.

The local or remote device-embedded function 157 to be invoked is specified as an invoked party in the data required to be communicated by the client program 101. The communication data required to be communicated by the client program 101 is transmitted to the remote transmitter 104 or the local transmitter 103 selected by the transmitter selector 102 as the XML message 110. The remote transmitter (remote transmission class) 104 and the local transmitter (local transmission class) 103 implement the common transmission interface 106. Therefore, the client program 101 can transmit the XML message 110 without taking into account which transmitter is used.

Since it is not required to take into account whether the remote or local transmitter is used, the same client program 101 can be used regardless of whether the communication is local or remote, thus the program size can be reduced.

The XML message 110 transmitted in this manner is received at the remote receiver 152 or the local receiver 153. If the local device-embedded function is specified as the invoked party, the sender side system 100 and the receiver side system 150 are common. The message distributor 154 determines that the XML message 110 is transmitted to which of one or more device-embedded functions 157. Then depending on the result of the determination, the XML message 110 is transmitted to the device-embedded function 157 via the device-embedded function adapter 156. Each device-embedded function adapter 156 has a common reception interface 155. Therefore, the message distributor 154 can deliver the XML message 110 without taking into account the differences of the device-embedded functions 157.

The same device-embedded function 157 can be used regardless of whether it is invoked locally or remotely. This allows the program size to be reduced. Further, providing the local transmitter 103 and the local receiver 153 corresponding to the remote transmitter 104 and the remote receiver 152 respectively allows an implementation optimized for local invocation. This allows the processing time of the communication to be reduced without overhead via a network.

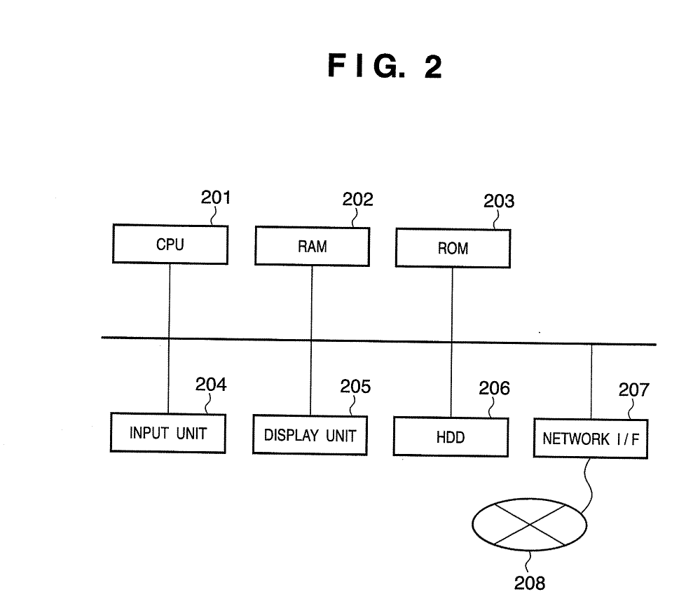

FIG. 2 is a block diagram describing a hardware configuration of a communication apparatus according to the present embodiment.

A CPU 201 controls operation of the entire apparatus according to the program loaded to a RAM 202 or stored in a ROM 203. The RAM 202 provides a work area for temporarily storing various data at control operation. The ROM 203 stores a boot program and various data. An input unit 204 has a keyboard and a pointing device such as a mouse, and is operated by a user and used to input various data and commands. A display unit 205 has a display panel such as a CRT or liquid crystal display and is used to display a message or data to a user. An external storage device (HDD) is a mass storage unit on which programs such as various applications and OS are installed. In response to these programs are invoked, they are read and loaded to the RAM 202, and is executed under the control of the CPU 201. The network interface (I/F) 207 controls the communication with a network 208.

The function of each unit in FIG. 1 is provided, for example, by executing programs by the CPU 201 loaded to the RAM 202.

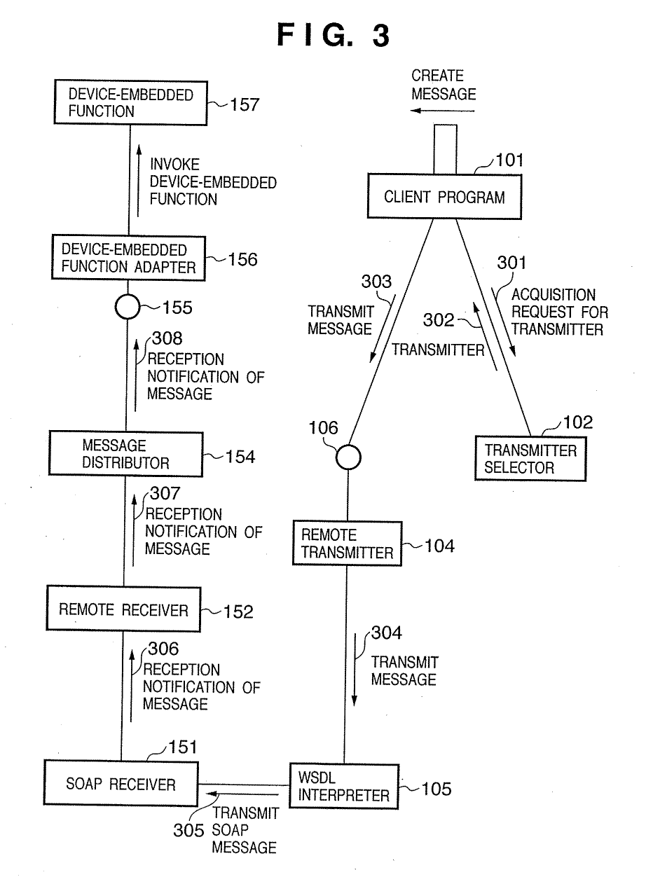

FIG. 3 is a block diagram describing a remote communication in the communication system according to the present embodiment. Although a program execution environment, a utility program, a program library and the like are required for executing the data communication programs according to the present embodiment, these are not shown in the figure.

The client program 101 issues an acquisition request (301) for a transmitter (local transmitter 103 or remote transmitter 104) to the transmitter selector 102 by specifying a destination. Based on the destination, the transmitter selector 102 determines whether the destination is the same local node or another remote node. Based on the determination, the transmitter selector 102 returns to the client program 101, specification information (302) specifying that the transmitter to be used is local or remote. Here, if the destination is local, the local transmitter 103 is transferred to the client program 101. On the other hand, if the destination is remote, the remote transmitter 104 is transferred to the client program 101. As a result, the client program 101 sends the XML message 110 and the destination (303) to the transferred local transmitter 103 or remote transmitter 104 via the common transmission interface 106.

If the communication is destined for remote, the remote transmitter 104 is selected. The remote transmitter 104 receives the destination and the XML message 110 via the transmission interface 106 and transmits them (304) to the WSDL interpreter 105. Having received the destination and the XML message 110, the WSDL interpreter 105 formats them as a SOAP message and transmits it (305) to the remote SOAP receiver 151.

Having received the SOAP message, The SOAP receiver 151 transmits it (306) along with a reception notification of the message. The remote receiver 152 separates the SOAP message into the XML message 110 and the destination, and transmits (307) the destination, the XML message 110 and the reception notification of the message to the message distributor 154. Having received the reception notification of the message from the remote receiver 152, the message distributor 154 transmits (308) an XML message 110 and the reception notification of the message to the device-embedded function adapter 156 determined from the destination via the reception interface 155. In this manner, the device-embedded function adapter 156 invokes the device-embedded function 157 associated with it.

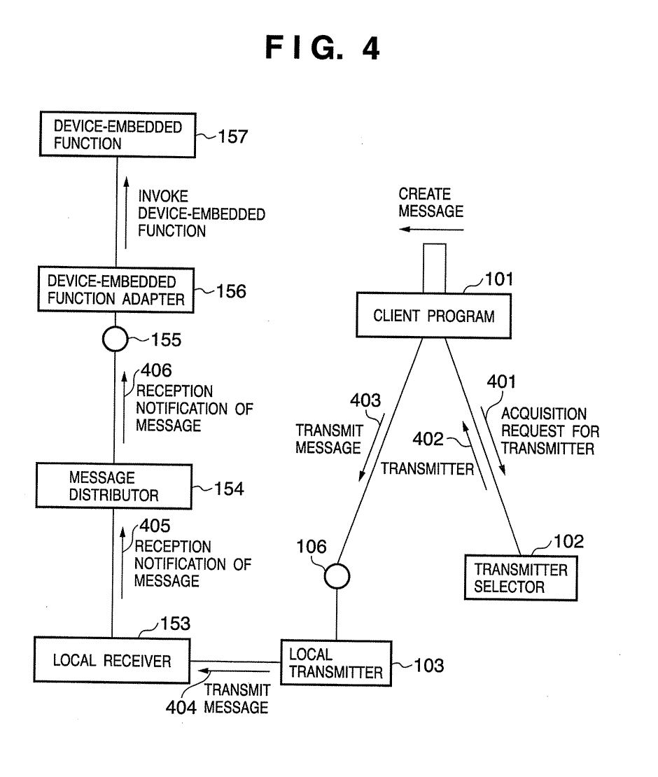

FIG. 4 is a block diagram describing a local communication in the communication system according to the present embodiment. Although a program execution environment, a utility program, a program library and the like are required for executing the data communication programs according to the present embodiment, these are not shown in the figure.

The client program 101 issues an acquisition request (401) for a transmitter to the transmitter selector 102 by specifying a destination. Based on the destination, the transmitter selector 102 determines whether the destination is the same local node or another remote node. Based on the determination, the transmitter selector 102 returns (402) to the client program 101, specification information specifying that the transmitter to be used is local or remote. Here, if the destination is local, the local transmitter 103 is transferred to the client program 101. As a result, the client program 101 transmits (403) the XML message 110 and the destination to the transferred local transmitter 103 via the common transmission interface 106.

Having received the destination and the XML message via the transmission interface 106, the local transmitter 103 directly invokes (404) the local receiver 153 within its own node using the XML message 110 and the destination. In this case, the sender side system 100 and receiver side system 150 are within the same node. The local receiver 153 invoked in this manner transmits (405) the destination, XML message 110 and the reception notification of the message to the message distributor 154.

Having received the reception notification of the message from the local receiver 153, the message distributor 154 transmits (406) the XML message 110, the reception notification of the message to the device-embedded function adapter 156 determined from the destination via the reception interface 155. In this manner, the device-embedded function adapter 156 invokes the device-embedded function 157 associated with it.

As described above, according to the present embodiment, in a program creation or maintenance environment, systems distributed in a network can communicate in a single process without taking into account whether the service is located on the same node as the client application program or another node in the network. If the service is located in the same network as the client application program, the overhead caused by using the network can be eliminated.

According to the present embodiment, a device-embedded function executed on the same node can be constructed as a service available to another node in a network without modification.

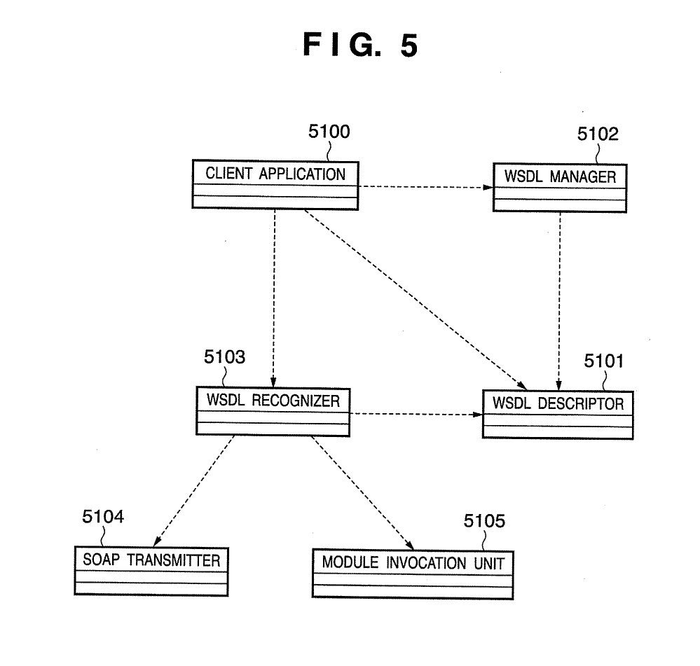

FIG. 5 is a conceptual diagram schematically showing a data communication system according to a second embodiment of the present invention. A hardware configuration of the communication device according to the present embodiment is the same as FIG. 2.

A sender side system of the data communication system according to the present embodiment has the following configuration. A client application 5100 utilizes a service located on its own node or another node located in a network. A WSDL (Web Service Description Language) descriptor 5101 describes the interface of the service. A WSDL manager 5102 manages the WSDL descriptor 5101 of the service in a name space. A WSDL recognizer 5103 reads and recognizes the content of the WSDL descriptor 5101. A SOAP transmitter 5104 is used by the WSDL recognizer 5103 for transmitting a SOAP message. A module invocation unit 5105 invokes the service module executed on the node where the client application 5100 is executed.

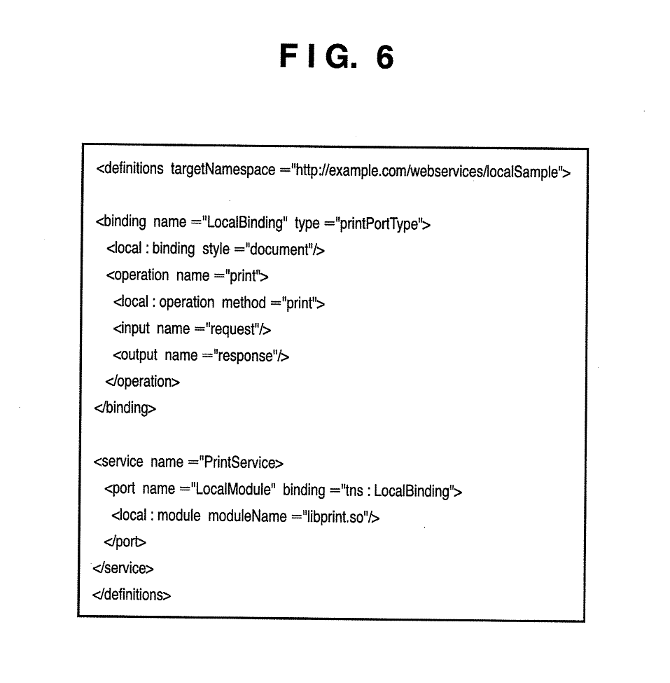

FIG. 6 depicts an example of WSDL extended to be executed on the same node in a network as the node where the client application 5100 is executed.

A binding element qualified by a local qualifier enables to recognize whether the interface indicated by the WSDL descriptor 5101 is the service executed on the same node in the network as the client application 5100. Method attribute in an operation element qualified by the local qualifier allows method name (here, “print”) executed by the service to be recognized. Further, moduleName attribute (here, “libprint.so”) of a module element qualified by the local qualifier allows the program module describing the service to be recognized.

The service that the client application 5100 is required to communicate is managed by the WSDL manager 5102 associating the name space of the WSDL with the WSDL descriptor 5101. The WSDL descriptors 5101 include a WSDL descriptor extended to be executed on the node in a network where the client application 5100 is executed and a WSDL descriptor utilized by SOAPBinding. The WSDL descriptor extended to be executed on the node in a network where the client application 5100 is executed and the WSDL descriptor utilized by SOAPBinding have separate name spaces by targetNamespace attribute in a definition element shown in FIG. 6. This allows the service to be uniquely identified by each name space.

A data which is required to be communicated by the client application 5100 is transmitted to the WSDL recognizer 5103 for which WSDL is specified, and is processed according to the content of the WSDL descriptor 5101. That is, in the case of SOAPBinding, the data is transmitted to service of another node in the network via SOAP using the SOAP transmitter 5104. In the case of LOCALBinding, the data is invoked as a program on the same node in the network using the module invocation unit 5105.

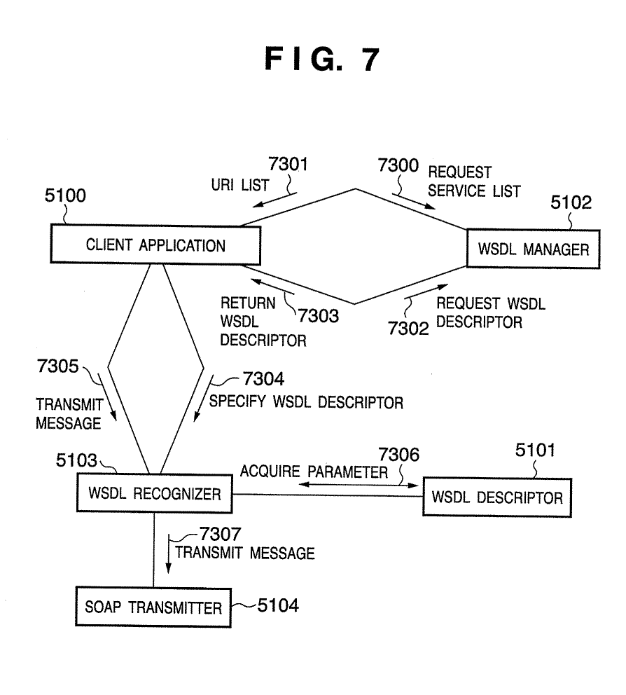

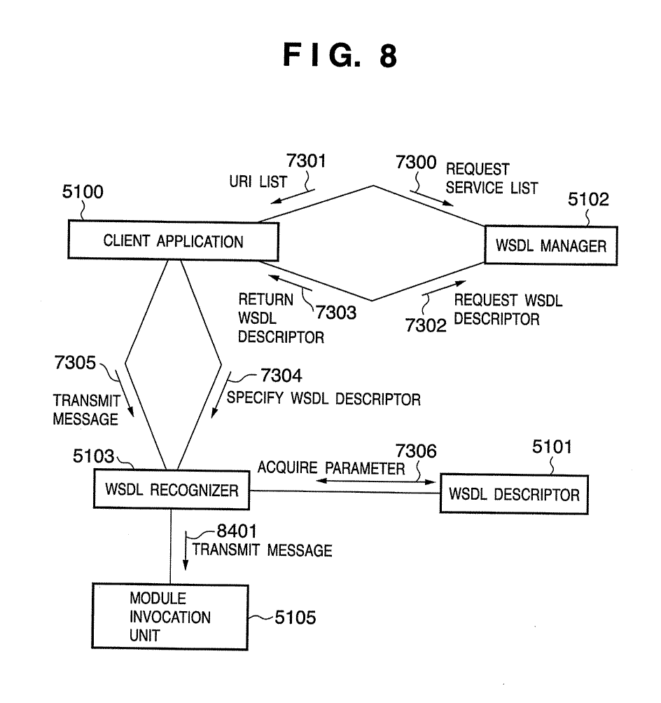

FIGS. 7 and 8 are collaboration diagram showing an example of functions of the service utilization system, apparatus and program according to the present embodiment. FIG. 7 shows an invoking process when the service is used, and FIG. 8 shows an invoking process when the program to be executed on the same node in the network is invoked. Although a program execution environment, a utility program, a program library and the like are required for executing the data communication programs according to the present embodiment, these are not shown in the figure.

The client application 5100 requests (7300) the WSDL manager 5102 for a list of services. An implementation using some search expression to narrow the services is also possible. The WSDL manager 5102 which is requested for the list returns (7301) a list of URI identified in the name space to the client application 5100. This allows the client application 5100 to identify any URI to be utilized. The client application 5100 requests (7302) the WSDL manager 5102 for the WSDL descriptor 5101 with that URI. If the URI has been previously identified, the client application 5100 may request the WSDL descriptor 5101 without an issuance of an acquisition request 7300. The WSDL manager 5102 which has been requested for the WSDL descriptor 5101 returns (7303) it from the URI transmitted on its request to the client application 5100.

The client application 5100 specifies (7304) the WSDL descriptor 5101 returned from the WSDL manager 5102 for the WSDL recognizer 5103. At this point, the client application 5100 caches the WSDL descriptor 5101. This allows the client application 5100, for using the WSDL descriptor 5101 defined in the same name space the next time, to specify the WSDL descriptor 5101 for the WSDL recognizer 5103 using the WSDL descriptor 5101 stored in its own cache. Therefore, in this case, the client application 5100 is not required to query the WSDL manager 5102 for the WSDL descriptor 5101.

Next, the client application 5100 transmits the message (7305) that is the data to be communicated to the WSDL recognizer 5103. The WSDL recognizer 5103 acquires (7306) each parameter from the WSDL descriptor 5101 specified in its own. If there is a SOAPBinding element in the binding element, the WSDL recognizer 5103 transmits (7307) the message along with each parameter.

FIG. 8 shows an invocation process for invoking a program executed on the same node in a network in which the parts common to FIG. 7 described above are designated as the same reference numerals and not described again.

In FIG. 8, since the WSDL recognizer 5103 is executed on the same node in a network if there is a LOCALBinding element in the binding element, the WSDL recognizer 5103 transmits (8401) the message along with each parameter to the module invocation unit 5105. The other parts are same as those in FIG. 7.

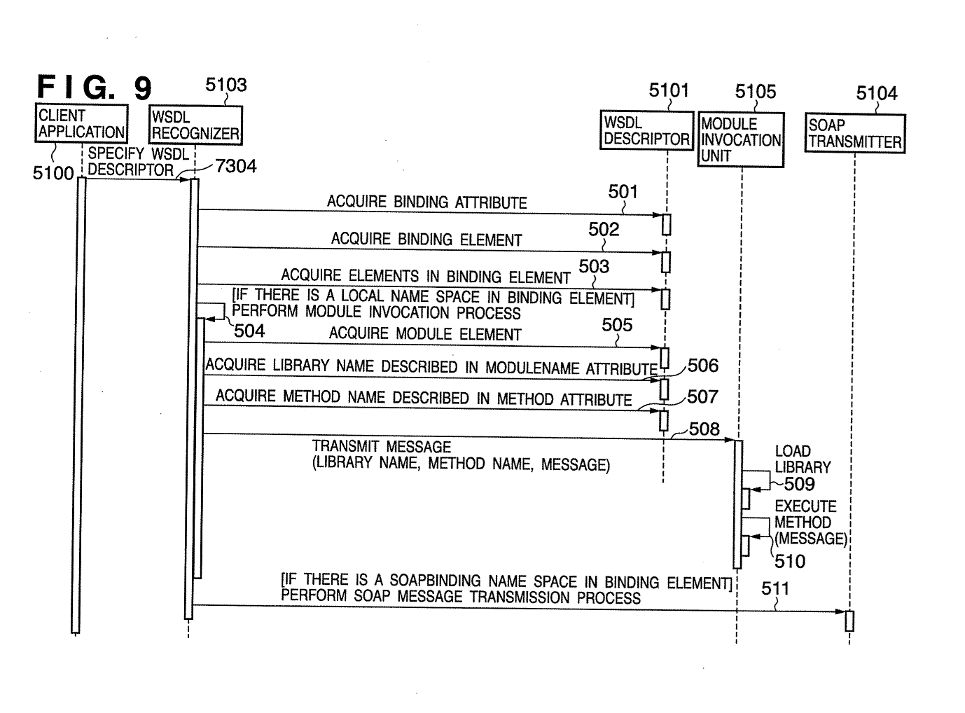

FIG. 9 is a sequence diagram describing in more detail the internal operation of the WSDL recognizer 5103 according to the present embodiment.

The client application 5100 specifies the WSDL descriptor 5101 for the WSDL recognizer 5103. This corresponds to the processes 7304 shown in FIGS. 7 and 8.

The WSDL recognizer 5103 acquires binding attribute (501) described in a service element in a definitions element from the WSDL descriptor 5101.

The WSDL recognizer 5103 acquires (502) from the descriptor 5101 a binding element in a definitions element having name as a string specified in the binding attribute acquired at (501).

The WSDL recognizer 5103 acquires (503) from the WSDL descriptor 5101 child elements of the binding element in the definitions element.

If there is a LOCALBinding element in the child elements of the binding element acquired by the WSDL descriptor 5101 at (503) (FIG. 8), the WSDL recognizer 5103 performs (504) a module invocation process.

The WSDL recognizer 5103 acquires (505) by the WSDL descriptor 5101 a LOCAL:module element in a port element in the service element in the definition element.

During the module invocation process, the WSDL recognizer 5103 acquires (506) by the WSDL descriptor 5101 library name from a module Name attribute in the LOCAL module element acquired at (505).

The WSDL recognizer 5103 acquires (507) by the WSDL descriptor 5101 method name transmitting the message from method attribute in a LOCAL operation element in the binding element acquired at (502).

During the module invocation process, the WSDL recognizer 5103 transmits (508) the message along with the library and method names to the module invocation unit 5105. This corresponds to the process shown at 8401 in FIG. 8.

The module invocation unit 5105 loads (509) the library transmitted from the library WSDL recognizer 5103.

The module invocation unit 5015 transmits the message (510) to a method having the method name transmitted from the WSDL recognizer 5103.

If there is a SOAPBinding element in child elements of the binding element acquired by the WSDL descriptor 5101 at (503) (FIG. 7), the WSDL recognizer 5103 performs a SOAP method transmission process (511) to the SOAP transmitter 5104. This corresponds to the process shown at 7307 in FIG. 7.

As described above, according to the present embodiment, in a program creation or maintenance environment, systems distributed in a network can communicate in a single process without taking into account whether the service is located on the same node as the client application or another node in the network.

If the service is located in the same network as the client application 5100, overhead associated with utilizing the network is eliminated.

Also, according to the present embodiment, the client application can identify the service without taking into account whether the service is located on the same node as the client application or another node in the network.

The present invocation may apply to a system composed of a plurality of devices (e.g., host computer, interface device, reader, printer, etc.) or a single device (e.g., copying machine, facsimile machine, etc.)

The objects of the present invention is achieved by attaching to a system or device a storage medium recording a software program code for providing the functions of the embodiments described above, and reading and executing the program code installed from the storage medium. In this case, the program code itself read out from the storage medium would provide the functions of the embodiments described above, and the storage medium storing the program code would constitute the present invention.

The storage medium providing the program include, for example, a hard disk, optical disk, magneto-optical disk, MO, CD-ROM, CD-R, CD-RW, magnetic tape, non-volatile memory card and the like. Further, they also include ROM and DVD (DVD-ROM, DVD-R).

Further, it may be possible to connect a home page in the Internet using a browser in the client computer and to download the computer program itself of the present invention or a compressed file including automatic installation function into the storage medium. Further, it may be possible to divide the program code constituting the program according to the present invention into a plurality of files and to download these files from different home pages. That is, the clams of the present invention include a WWW server allowing a plurality of users to download program files for implementing the functional process according to the present invention as a computer.

The present invention is not limited to the case where the functions according to the above-described embodiments are provided by executing the program code being read by a computer. That is, the present invention includes the case where OS (Operating System) or the like running on the computer performs some or all of the actual process, thereby the functions according to the above-described embodiments are provided.

Further, the present invention also includes the case where the program code being read from the storage medium is written into a memory included in a functional expansion board inserted into the computer or a functional expansion unit connected to the computer, then CPU included in the functional expansion board or unit performs some or all of the actual process, thereby the functions according to the above-described embodiments is provided.

While the embodiments according to the present invention have been described above, the present invention is not limited to the above-described embodiments, and it may be modified without departing from the spirit of the present invention.

This application claims the benefit of Japanese Patent Application No. 2005-261099, filed Sep. 8, 2005, and Japanese Patent Application No. 2005-298097, filed Oct. 12, 2005, which are hereby incorporated by reference herein in their entirety.

What is claimed is:

1. A communication method comprising the steps of:
selecting one of remote and local transmitters;
transmitting a message from the transmitter selected in said selecting step;
receiving the message at a receiver; and
transmitting the message to the destination of the message received in said receiving step.

2. The method according to claim 1, wherein in said transmitting step, the message is transmitted to an adapter for invoking function, the adapter being the destination.

3. A communication apparatus comprising:
selection means for selecting one of remote and local transmitters according to the destination of a message;
first transmission means for transmitting the message from the transmitter selected by said selection means;
reception means for receiving the message at a receiver; and
second transmission means for transmitting the message to the destination of the message received by said reception means.

4. The apparatus according to claim 3, wherein said second transmission means transmits the message to an adapter for invoking function, the adapter being the destination.

5. A communication system comprising:
a transmission interface configured to transmit a message;
local transmission means for transmitting the message transmitted from said transmission interface to a local destination;
remote transmission means for transmitting the message transmitted from said transmission interface to a destination on a network;
local reception means for receiving the message transmitted to said local destination;
remote reception means for receiving the message from the network; and
an adapter configured to receive the message received by said local or remote reception means.

6. The system according to claim 5, wherein said local and remote reception means comprise transmission means for transmitting the message to the adapter invoking function, the adapter being the destination.

7. A communication method comprising:
a first transmission step of transmitting a message transmitted from a transmission interface to a local destination;
a second transmission step of transmitting the message transmitted from the transmission interface to a destination on a network;
a local reception step of receiving the message transmitted to the local destination;
a remote reception step of receiving the message from the network; and
a processing step of processing the message received in said local or remote reception step.

8. The method according to claim 7, wherein said processing step comprises a step of transmitting the message to an adapter for invoking function, the adapter being the destination.

9. A computer program for a computer making communication, comprising the steps of:
selecting one of remote and local transmitters according to the destination of a message;
transmitting the message from the transmitter selected in said selection step;
receiving the message at a receiver; and
transmitting the message to the destination of the message received in said receiving step.

10. The program according to claim 9, wherein in said transmitting step, the message is transmitted to an adapter for invoking function, the adapter being the destination.

11. A processing method for processing Web service description, comprising the steps of:
acquiring a parameter from the Web service description; and
selecting a remote transmitter or an invocation unit in a local module according to the parameter acquired in said acquiring step.

12. The method according to claim 11, further comprising a step of transmitting a message from the remote transmitter to a node on a network.

13. The method according to claim 11, wherein the Web service description selecting the remote transmitter and the Web service description selecting the invocation unit in the local module have different name spaces from each other.

14. A processing apparatus for processing Web service description, comprising:
processing means for acquiring a parameter from the Web service description; and
selection means for selecting a remote transmitter or an invocation unit in a local module according to the parameter acquired by said processing means.

15. The apparatus according to claim 14, further comprising means for transmitting a message from the remote transmitter to a node on a network.

16. The apparatus according to claim 14, wherein the Web service description selecting the remote transmitter and the Web service description selecting the invocation unit in the local module have different name spaces from each other.

17. A computer program for a computer for processing Web service description, comprising the steps of:
acquiring a parameter from the Web service description; and
selecting a remote transmitter or an invocation unit in a local module according to the parameter acquired in said acquiring step.

18. The program according to claim 17, further comprising a step of transmitting a message from the remote transmitter to a node on a network.

19. The program according to claim 17, wherein the Web service description selecting the remote transmitter and the Web service description selecting the invocation unit in the local module have different name spaces from each other.
